(19) United States
(12) Patent Application Publication
(10) Pub. No.: US 2026/0360058 A1
(43) Pub. Date: Nov. 12, 2026

(54) METHOD FOR DIFFUSION MODEL GUIDED HUMAN-OBJECT INTERACTION GENERATION WITH 3D GAUSSIAN

(71) Applicant: NEC Laboratories America, Inc., Princeton, NJ (US)

(72) Inventors: Deep Patel, Mount Holly, NJ (US); Renqiang Min, Princeton, NJ (US); Shurui Gui, San Mateo, CA (US)

(21) Appl. No.: 19/662,529

(22) Filed: Apr. 29, 2026

Related U.S. Application Data
(60) Provisional application No. 63/802,679, filed on May 9, 2025.
(60) Provisional application No. 63/979,593, filed on Feb. 10, 2026.

(51) Int. Cl. G06T 13/20; G06T 15/08; G06T 17/20

(52) U.S. Cl. CPC G06T 13/20; G06T 15/08; G06T 17/20; G06T 2210/12; G06T 2210/21

(57) ABSTRACT

Systems and methods are described for diffusion model guided human-object interaction generation with a three-dimensional (3D) Gaussian. The systems and methods include prompting a large language model (LLM) to generate a trajectory, the LLM applying motion priors, reviewing the trajectory with a collision detector, wherein the LLM and the collision detector iteratively refine the trajectory to ensure the trajectory adheres to laws of physics, and generating a motion sequence from the trajectory. The systems and methods further include forming a three-dimensional (3D) Gaussian image of a human that follows the motion sequence, merging the 3D Gaussian image of the human with a 3D Gaussian image of an object, applying collision detection to the 3D Gaussian image of the human and the 3D Gaussian image of an object and generating a video from the motion sequence.

### RELATED APPLICATION INFORMATION

This application claims priority to U.S. Provisional Patent Application No. 63/802,679, filed on May 9, 2025, and U.S. Provisional Patent Application No. 63/979,593, filed on Feb. 10, 2026, incorporated herein by reference in their entirety.

### BACKGROUND

### Technical Field

The present invention relates to computer vision techniques and more particularly a method for artificial intelligence (AI) model guided human-object interaction generation.

### Description of the Related Art

Video generation models have been used to generate two-dimensional (2D) videos that can look realistic. One technique for generating videos is through the use of video diffusion models. Video diffusion models can, however, sometimes generate unrealistic deformations, twists, penetrations, and semantic violations (e.g., violate the laws of physics). These issues are often considered to be a result of the lack of learned physics.

Many video generation models have addressed these issues by using trajectory tracking, occlusion masks, and semantic masks, etc., but there are still issues with the feasibility of these solutions without introducing extra information equivalent to physical information in a three-dimensional (3D) space. The solutions that include information from a 3D space often extract prior knowledge from 2D diffusion models and consequently inherit many of the drawbacks of 2D diffusion models.

Further, four-dimension (4D) video generation techniques adopt pre-trained video diffusion models as well. However, the generation ability cannot go beyond the original distribution of the pre-trained diffusion models and also share the same limitations as the original 2D pre-trained diffusion models.

Compositional 4D video generation has been developed to overcome this issue, which incorporates and combines multiple prior distributions to generate samples with novel distributions. However, the motion information from the pre-trained video diffusion model inherits its original distortions, especially on human-related motions, like the 3D video generation.

Another drawback of video generation solutions in the prior art is that many solutions are associated with specific models with limited datasets and have difficulty generating videos for domains the models are not trained on.

### SUMMARY

According to an aspect of the present invention, a method is provided for diffusion model guided human-object interaction generation with three-dimensional (3D) Gaussian. The method includes prompting a large language model (LLM) to generate a trajectory, the LLM applying motion priors, reviewing the trajectory with a collision detector, wherein the LLM and the collision detector iteratively refine the trajectory to ensure the trajectory adheres to laws of physics, and generating a motion sequence from the trajectory. The method further includes forming a 3D Gaussian image of a human that follows the motion sequence, merging the 3D Gaussian image of the human with a 3D Gaussian image of an object, applying collision detection to the 3D Gaussian image of the human and the 3D Gaussian image of an object, and generating a video from the motion sequence.

According to another aspect of the present invention, a system is provided for diffusion model guided human-object interaction generation with 3D Gaussian. The system includes a processor and a memory. The memory stores computer-readable instructions that when executed by the processor, cause the processor to prompt a LLM to generate a trajectory, the LLM applying motion priors, review the trajectory with a collision detector, wherein the LLM and the collision detector iteratively refine the trajectory to ensure the trajectory adheres to laws of physics, and generate a motion sequence from the trajectory. The system further includes memory to cause the processor to form a 3D Gaussian image of a human that follows the motion sequence, merge the 3D Gaussian image of the human with a 3D Gaussian image of an object, apply collision detection to the 3D Gaussian image of the human and the 3D Gaussian image of an object, and generate a video from the motion sequence.

According to yet another aspect of the present invention, a computer program product is included. The computer program product includes a non-transitory computer-readable storage medium containing computer program code, the computer program code when executed by one or more processors causes the one or more processors to perform operations. The computer program code includes instructions to perform a diffusion model guided human-object interaction generation with 3D Gaussian. The instructions further cause the one or more processors to prompt a LLM to generate a trajectory, the LLM applying motion priors, review the trajectory with a collision detector, wherein the LLM and the collision detector iteratively refine the trajectory to ensure the trajectory adheres to laws of physics, and generate a motion sequence from the trajectory. Additionally, the computer program product further includes instructions to form a 3D Gaussian image of a human that follows the motion sequence, merge the 3D Gaussian image of the human with a 3D Gaussian image of an object, apply collision detection to the 3D Gaussian image of the human and the 3D Gaussian image of an object, and generate a video from the motion sequence.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a portion of a high-level system for diffusion model guided human-object interaction generation with 3D Gaussian, in accordance with an embodiment of the present invention;

FIG. 2 is a block diagram illustrating a portion of a high-level system for diffusion model guided human-object interaction generation with 3D Gaussian, in accordance with an embodiment of the present invention;

FIG. 3 is a block diagram illustrating a portion of a high-level system for diffusion model guided human-object interaction generation with 3D Gaussian, in accordance with an embodiment of the present invention;

FIG. 4 is a block diagram illustrating a system employing diffusion model guided human-object interaction generation with 3D Gaussian, in accordance with an embodiment of the present invention;

FIG. 5 is a flow diagram illustrating a method for diffusion model guided human-object interaction generation with 3D Gaussian, in accordance with an embodiment of the present invention; and

FIG. 6 is a block diagram illustrating a system for an environment of executing a diffusion model guided human-object interaction generation with 3D Gaussian, in accordance with an embodiment of the present invention.

### DETAILED DESCRIPTION OF PREFERRED EMBODIMENTS

Embodiments of the present invention generate videos by employing an object-aware four-dimensional (4D) human motion generation framework grounded in 3D Gaussian representations and motion diffusion priors. The videos can avoid unrealistic deformations, semantic violations, and physical inconsistencies that are largely rooted in the absence of three-dimensional (3D) physical priors.

In other words, video generation can be improved by adopting a framework that employs spatial and prompt semantic information in large language models (LLMs) and motion priors to generate realistic (e.g., believable) videos. The motion priors can include rigid body motion priors, articulated motion priors, temporal continuity priors, velocity consistency priors, trajectory smoothness priors, Newtonian motion priors, momentum conservation priors, energy conservation priors, force-response priors, mass-dependent motion priors, gravity priors, ground plane priors, friction priors, air resistance/damping priors, collision priors, contact consistency priors, action-reaction priors, support relationships priors, elasticity priors, plasticity priors, material consistency priors, optical flow consistency priors, occlusion-aware motion priors, static background priors, sparse motion priors, object permanence priors, causal motion priors, pose manifold priors, joint limit priors, gait regularity priors, etc.

The combination and integration of the framework and one or more LLMs enables spatial-aware motion optimization. One or more score gradients can be determined from pre-trained motion diffusion models to refine human motion while respecting object and semantic constraints. While the term human and other terms relating to natural persons may be used throughout, embodiments of the present invention contemplate using other objects such as other animals, robots, or other objects that are not andromorphic or otherwise living organisms in nature.

Embodiments of the present invention employ zero-shot to avoid retraining of the model and generalizing out-of-distribution object-aware human motions. In other words, since videos including human-object interactions often use the joint distribution of humans and objects for training and the sizes of these datasets are limited, there is difficulty generating any out-of-distribution scenarios. Out-of-distribution data refers to inputs that differ from the training data, potentially resulting in reduced accuracy or unreliable model outputs. The framework addresses this difficulty by distilling information from dedicated motion models. This guides the motion optimization process using zero shot learning so that scenarios that the model has not encountered before can be generated in a manner that is realistic.

Embodiments of the present invention avoid additional motion diffusion model (MDM) training and can achieve realistic interactions between humans and static objects with MDM score distillation sampling (MSDS).

Three-dimensional (3D) Gaussian splatting (3DGS) can be used to generate a 3D scene that is incorporated into the video. 3D Gaussian splatting is helpful because the technique can include explicit 3D space representations, is highly optimizable, and the optimization can be performed efficiently. The individual units of 3DGS are 3D Gaussian ellipsoids, where each 3D Gaussian is parameterized with the optical characteristics μ was the position, anisotropic covariance Σ as the shape, a as the opacity, and sh as the spherical harmonic coefficients, where sh is a view-dependent property. The shape of the 3D Gaussian Σ can be considered as the composition of a scaling and a rotation according to Σ=RSS^{T}R^{T} where the scaling matrix S can be denoted as a 3D vector s, T is a vector transpose, and the rotation matrix R as a quaternion q∈SO(3) where SO(3) is the group of rotations about the origin of three-dimensional Euclidean space [symbol] ³ under the operation of composition, which combines two rotations by performing the rotations sequentially. Therefore, the Gaussian centered at point μ is can be defined as

$$G ( x , μ ) = {e}^{- \frac{1}{2} {( x - μ )}^{T} {\sum }^{- 1} ( x - μ )}$$

where x is a random variable in 3D space.

To render 3D Gaussians into a two-dimensional (2D) image, 3DGS considers the additional opacity and spherical harmonic coefficients by utilizing a tile-based rasterizer and point-based a-blend rendering. For each pixel u, its color C(u) is rendered under

$$C ( u ) = {\sum }_{i ∈ N} {T}_{i} {c}_{i} {α}_{i} 𝒮ℋ ( {sh}_{i} , v )$$

$${T}_{i} = G ( x , {μ}_{i} ) {\prod }_{j = 1}^{i - 1} ( 1 - {α}_{j} G ( x , {μ}_{j} ) )$$

where Tᵢ denotes the transmittance for the i-th Gaussian function G, [symbol] denotes the spherical harmonic function, and v represents the viewing direction. The 3D Gaussian optimization process includes adjusting 3D Gaussian properties {μ, q, s, σ, c} and the high-level 3D Gaussian density modifications using densifying and pruning processes.

The 3DGS can form a human in a scene using Skinned Multi-Person Linear (SMPL) models. SMPL models represent a human by transforming the human mesh of a standard pose and the canonical model into the observation space, using pose parameter θ, shape parameter β, and expression parameter φ:

M(β,θ,φ)=LBS(P(β,θ,φ),J(β),θ, W),

P(α,θ,φ)=P+Bₛ(β)+Bₑ(φ)+Bₚ(θ)

where M is the function mapping parameters to a transformed human mesh model, P represents a base template and P(β, θ, φ) is base template adjusted for body shape, expression, and pose using human key points/vertices via functions Bₛ, Bₑ, and Bₚ, respectively, and J is a set of skeleton joint positions.

Given the transformed vertices, the skins of the human mesh can be adjusted according to the transformations of several nearby joints, which is performed by the linear blend skinning function (LBS (⋅)) where W stands for blend weights that determine the effects from different joints. Specifically, the LBS process is defined as:

$${v}_{o} = 𝒢 \cdot {v}_{c} , 𝒢 = {\sum }_{k = 1}^{K} {w}_{k} {𝒢}_{k} ( θ , {j}_{k} )$$

where the vertices vₒ in the observation space is deformed from the canonical pose vertices v_{c} by the deformation [symbol] , wₖ is the weight of the joint influence on the skinning for that vertex, jₖ is the joint for the k-th index (e.g., elbow, hip, etc.). The deformation is determined by the affine deformation [symbol] ₖ(θ, jₖ) that merges the warping effects from K neighboring joints, simulating the smooth position changes of vertices.

The framework, which can be an object-aware human motion generation (OAHM) framework leverages pre-trained motion priors within an explicit optimization paradigm to avoid pitfalls of zero-shot learning. In other words, new motion is generated without training on that specific case by using a pre-learned understanding of realistic motion and determining the result using an optimization process that balances realism and data fitting.

With expressive 3D representations third-party solutions such as, e.g., HumanGaussian™ OAHM framework can generate high-fidelity 3D human Gaussians Gₕ from textual prompts, and utilize other third-party solutions such as, e.g., DreamGaussian™, to synthesize 3D objects from an initial SHAP-E™ geometry. An LLM or other natural language processing (NLP) implementations can be used to aid in converting textual prompts into videos. Embodiments of the present invention can employ proprietary or third-party solutions to generate or process any number of aspects of the video.

Given a motion sequence X, a correspondence between the motion trajectory and the human Gaussian points Gₕ can be established, enabling dynamic Gaussian-based human motion. A SMPL-eXpressive (SMPL-X) model can be initialized in a rest pose, consistent with the canonical configuration of the human Gaussian points. Each Gaussian point is then mapped to the barycentric coordinate on the corresponding SMPL-X mesh face.

By preserving these fixed barycentric correspondences, any transformation applied to the SMPL-X mesh is propagated to the associated Gaussian points, ensuring coherent deformation of the 3D human representation. This mapping is differentiable, enabling gradients back propagation. In other embodiments of the present invention Gaussian points can be generated by recalculating or interpolating LBS weights.

With a controllable Gaussian human and an independently generated Gaussian object co-located in the same coordinate system, interactive sequences can be rendered via Gaussian splatting.

To extract meaningful and realistic human motion distributions, embodiments of the present invention avoid relying on video diffusion models as doing so can lead to unrealistic results. Instead, a human MDM can be employed. An embodiment of the present invention can use a MDM that includes an N-length motion sequence

$$X = {\{ {x}^{i} \}}_{i = 1}^{N} ,$$

where each frame xⁱ∈ [symbol] ^{3+6+J×6} (3 translation values, 6 global orientation values) encodes the pose parameters θⁱ∈ [symbol] ^{J×6}, global translation rⁱ∈ [symbol] ³, and 6D global orientation [symbol] ⁱ∈ [symbol] ⁶. Other parameters, such as body shape are also contemplated. During the MDM process, the N-frame motion sequence X is subject to T steps of Gaussian noise:

q(Xₜ|Xₜ₋₁)= [symbol] (\sqrt{α}Xₜ₋₁,(1−αₜ)I)

where t∈{1, . . . , T} denotes the diffusion step and X_{T}~ [symbol] (0, I), where I is the identity matrix. The MDM is trained to predict the clean motion \hat{X}₀ given a noisy motion Xₜ.

LLMs with spatial and reasoning capabilities (e.g., priors) are utilized to aid in addressing limitations associated with directly sampling from MDMs. While MDMs capture temporal and kinematic structure, the models can fail to guarantee meaningful object-aware motions since the models lack explicit spatial awareness useful for modeling relationships between humans. Additionally, guidance from 2D image or video diffusion models can provide unreliable spatial supervision signals. To address these limitations, an LLM can be used to generate a coarse global trajectory for a human subject based on input information including initial coordinates of the human and one or more objects, as well as a textual motion instruction. This trajectory can then be used to guide or condition motion generation for refinement using the MDM. This LLM-derived trajectory, denoted as

$${r}_{L L M}^{i}$$

for i=1, . . . , NV, can be further refined using trajectory interpolation and collision detection, enabling the system to produce physically plausible paths, such as, e.g., including detours around obstacles, realistic speeds/velocities/acceleration/jerk, avoid object penetration, etc.

For example, when instructed to “walk four meters toward a table two meters away,” the LLM can synthesize a motion trajectory that navigates around the object. The LLM-generated trajectory is used to initialize the global translation in the MDM framework. With estimated time/frames and extracted pure motion prompt as two additional inputs, the MDM can yield a coarse motion sequence that incorporates spatial awareness following the trajectory. While the resulting motions can lack fine-grained realism, the motions provide a starting point for subsequent optimization. The LLM can be prompted by the OAHM framework to generate a trajectory based on a prompt which is used in the MDM. Put another way, the OAHM framework receives the human and object positions and textual motion instruction (walk, jump, etc.), and then prompts the LLM to generate a coarse trajectory based on these positions and motion information. The trajectory can be later refined to improve the realism aspects using the MDM and additional components.

Embodiments of the present invention also can generate realistic OAHM that enforces physical constraints such as, e.g., collision avoidance and trajectory fidelity by jointly refining human motion by leveraging the prior knowledge encoded in motion diffusion models, while explicitly enforcing trajectory, smoothness, and collision-avoidance constraints using a motion score distilled interaction.

Instead of generating human motions directly from the MDM, score (gradient) information is extracted from the MDM to guide the optimization of both trajectories and poses under physical constraints. Specifically, a motion diffusion score distillation sampling (MSDS) is included, which optimizes human motion X by maximizing the log-likelihood under the MDM prior. The gradient of the MSDS objective is given by

∇_{X} [symbol] _{MSDS}(φ) [symbol] [symbol] _{t,∈}[w(t)(X−MDM_{φ}(Xₜ,t,c))]

where MDMφ denotes the pre-trained MDM and w(t) is a weighting function over diffusion steps and a text condition c encoded by a contrastive-language-image pretraining (CLIP)-based text encoder. This process aligns the optimized motion with the learned distribution of human poses and trajectories. Alternatives to CLIP are also contemplated, such as, e.g., vision transformers (ViTs), multimodal LLMs (MLLMs), bootstrapping language image pretraining (BLIP), etc.

To ensure the resulting motions are physically plausible and interact naturally with the object, explicit constraints are also incorporated. The optimized trajectory is regularized to remain close to the LLM-generated coarse trajectory. The trajectory loss is defined as

$${ℒ}_{T r a j} = {λ}_{m i d d l e} \cdot {\sum }_{i = 2}^{N - 1} {‖ {r}^{i} - {r}_{L L M}^{i} ‖}_{2}^{2} + {λ}_{e n d} {\sum }_{i ∈ \{ 1 , N \}} {‖ {r}^{i} - {r}_{L L M}^{i} ‖}_{2}^{2}$$

where λ_{middle} and λ_{end} control the fidelity at middle and endpoint frames, respectively.

To prevent unnatural or abrupt changes in motion, a jerk (third derivative of motion) regularization is introduced

$${ℒ}_{s m o o t h} = {\sum }_{i = 1}^{N} {‖ \frac{{d}^{3} {r}^{i}}{d {t}^{3}} ‖}_{2}^{2}$$

where in practice, the derivative is approximated using finite differences over adjacent frames.

To prevent human-object penetration, a two-stage collision detection and penalty scheme is employed. The intersection [symbol] of 3D bounding boxes for the human and object is computed. If [symbol] is non-empty, pairwise collisions between object points oᵢ∈ [symbol] and their human points hⱼ∈ [symbol] is evaluated. Collision loss is then given by

[symbol]

_{collision}=max(nⱼ·(hⱼ−oⱼ),−∈_{c}

where nⱼ is the normal vector at hⱼ and ∈_{c} is a collision margin hyperparameter. Collision loss can be the same as collision detector. Collision loss ensures there is no penetration from controllable 3D Gaussian and the object depicted in 3D image by using bounding box(es).

The final loss function for human motion optimization combines the terms

[symbol]

=λ_{MSDS}· [symbol] _{MDSD}+λₜᵣₐⱼ· [symbol] ₜᵣₐⱼ+λₛₘₒₒₜₕ· [symbol] ₘₒₒₜₕ+λ_{collision}· [symbol] _{collision}

where λ_{MSDS}, λₜᵣₐⱼ, λₛₘₒₒₜₕ, and λ_{collision} are hyperparameters balancing the different objectives. This motion score distilled interaction constrained optimization aggregates gradients to the motion sequence X and updates the sequence. Through this optimization, the generated motions X are ensured to be realistic according to the learned motion diffusion prior, and spatially and physically consistent with the surrounding environment and objects.

Collision loss can enforce the optimization to enforce physical nonpenetration constraints. In other words, the generated human is prohibited from visibly penetrating or piercing objects. MSDS, L_{MSDS}, enhances the quality of the human motion and object interaction, particularly at contact points. Without L_{MSDS}, the human can appear to float or make unnatural contact.

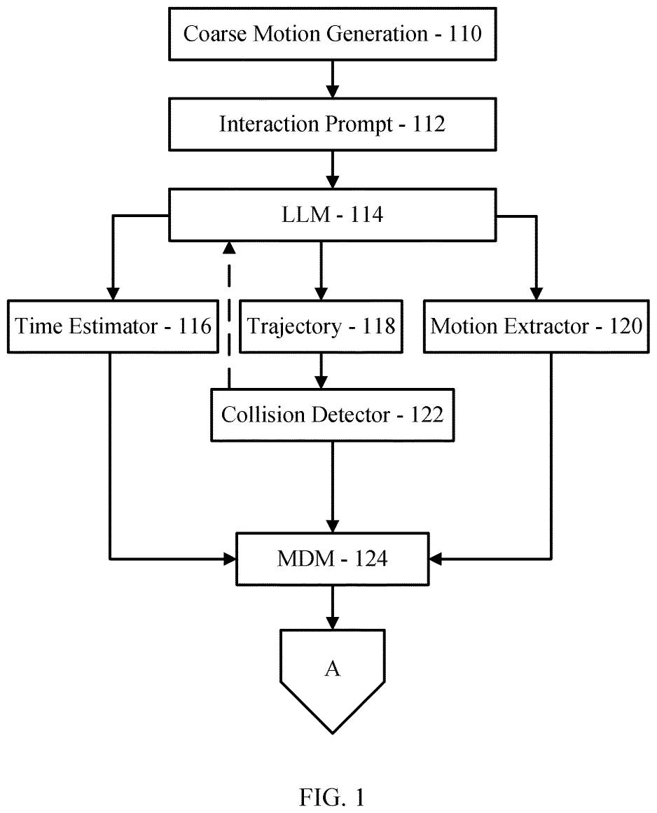

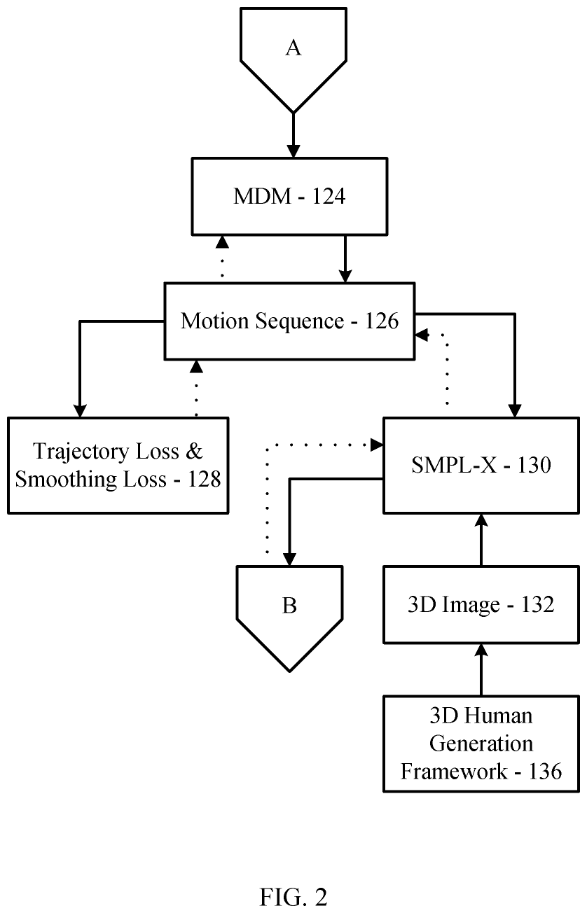

Referring now in detail to the figures in which like numerals represent the same or similar elements and initially to FIGS. 1, 2, and 3, a high-level block diagram for a method for diffusion model guided human-object interaction generation with 3D Gaussian. Interaction prompt 112 can be generated and input into LLM 114 to initiate the formation of a video. Interaction prompt 112 can include natural language text, such as, e.g., “a person jumps onto the table”, or “a person walks around the lamp”. Interaction prompt 112 can describe coarse motion generation 110 in some embodiments of the present invention.

LLM 114 is used to plan the trajectory 118 given the 3D initial position of the person and the object. LLM 114 also estimates, and outputs total video time 116 (time to traverse the total number of frames) based on interaction prompt 112. For example, two (2) seconds can be sixty (60) frames.

Motion extractor 120 is a module used to extract the motion verb from the prompt (e.g. jump, walk, etc.) and provide information about potential collisions. In an embodiment of the present invention, motion extractor 120 can be an LLM 114 prompt which asks LLM 114 to extract motion verbs from the prompt. In another embodiment of the present invention, motion extractor 120 can be a deep learning model trained to classify each word in the prompt sentence, and the classification result can be used to extract the verb.

LLM 114 generates a time estimate 116 for the duration of the video depicting interaction prompt 112, for example, e.g., jumping on a table can table 3 second, walking forward 20 feet towards, and around, a table can take 5 seconds. A number of frames per second can be fixed to optimize the motion within the estimated time 116. This ensures videos produced using LLM 114 have realistic motion as per the real dynamics of the verbs, e.g., not too fast or too slow. Motion extractor 120 is a verb extractor which extracts the motion verb from prompt 112. e.g. a person walks 4 units towards the table has a verb of “walks.” In other words, motion extractor 120 extracts the verb “walk.”

Collision detector 122 receives estimated trajectory 118 from LLM 114 and performs checks to verify whether trajectory 118 is valid. The checks can ensure trajectory 118 avoids collisions. Collision detector 122 can also ensure trajectory 118 is plausible (realistic), adheres to the law of physics, accurately reflects interaction prompt 112, etc. In an embodiment of the present invention, collision detector 122 can be implemented as a rule-based algorithm that verifies trajectory 118 per frame and can check for drastic changes in position across the frame and whether the 3D values are within the world space defined during LLM 114 prompting. If collision detector 122 determines that trajectory 118 is not valid, multiple iterations of LLM 114 prompting are performed to ensure the output path satisfies the conditions in the collision detector 122.

MDM 124 receives the action verb from motion extractor 120, trajectory 118 information (via collision detector 122) and total frames from time estimator 116 as input and outputs motion sequence 126, which includes body poses and translation that are input into 3D SMPL-X 130 as poses per frame. Trajectory 118 can be set (e.g., immutable) once received by MDM 124. In an embodiment of the present invention, MDM 124 can be a pretrained model which is pretrained to output SMPL-X 130 parameters across time given the input action verbs. The predicted SMPL-X 130 parameters can be interpolated across the trajectory 118 path as MDM 124 can output predicted poses of different lengths of predicted poses. In other words, SMPL-X 130 can transform (map) a mesh to a 3DGS. Motion sequence 126 can also be optimized with trajectory loss and smoothing loss 128. Interpolation can be implemented based on uniform distribution of the predicted poses across the total frames.

3D content generation framework 144 and human generation framework 136 can include the same model architecture which can output a 3D Gaussian splat or 3D mesh (e.g., 3D Gaussian 138) given an input prompt (e.g., interaction prompt 112). The outputs can be a static human(s) or object, for example, a person in red clothes, a brown table, etc.

SMPL-X 130 receives an output from 3D human generation framework 136 (3D image 132) and the pose predictions from the MDM 124 (motion sequence 126) and merges 140 the Gaussian splat or mesh with the SMPL-X 130 parameters. SMPL-X 130 processes the pose predictions to form controllable 3D Gaussian 138 prior to merge 140. 3D Gaussian 138 and 3D image 142 can translate (e.g. move) when input into merge 140. In other words, the 3D position of the human changes in the world space, and the 3D Gaussian 138 and 3D image 142 can move from one location to another in successive frames.

In an embodiment of the present invention, MDM 124 can be implemented by aligning the SMPL-X 130 pose parameters with the centroid of the mesh and/or Gaussian splats. The output from SMPL-X 130 is a merged Gaussian splat or mesh that can be controlled using the SMPL-X 130 parameters of the body pose.

The output merged 140 3D human image 132 Gaussian splat is translated and merged 140 in the scene with the 3D image 142 from 3D content generation framework 144, where 3D image 142 is an object Gaussian using the bounding box 146 coordinates of the human and the object generated from collision loss 148.

In embodiments of the present invention, a human is placed according to a start position in trajectory 118 and an object is placed at the origin of the scene. In an embodiment, the human and object are merged 140 using the same coordinate system so that human and object can be placed in the same 3D scene for subsequent optimization and interaction modeling. In an embodiment of the present invention, the merging can be performed using a rigid transformation based on the bounding box 146 coordinates, translation and rotation and scaling parameters to align the human, and object Gaussian splat within the scene. The human is placed at a distance from the object based on interaction prompt 112 in a heuristic manner.

After the placement of the human and the object, the human pose, human motion, and trajectory 118 are optimized by score distillation sampling from the human diffusion model (smoothing) and trajectory regularization losses 128. Multiple physical informed losses (collision loss 148) are also applied to ensure smoothness in the motion and collision free object interaction. In an embodiment of the present invention collision loss 148 can be implemented as minimization of the intersection over union of the 3D bounding boxes 146 of the human and the object. The realism of the motion can be measured by several metrics. These metrics quantize motion realism, diversity, and physical plausibility. These metrics measure pose realism, motion diversity, and temporal dynamics. Known metrics, such as optical flow score, or proprietary metrics can be implemented such as pose plausibility, pose variation, and trajectory length.

For each generated video, 3D human meshes are extracted by estimating SMPL parameters for every detected human instance using a vision transformer detector (ViTDet). From these per-frame SMPL models and multi-view RGB frames, pose plausibility, pose variation, trajectory length, and optical flow score can be computer.

Pose plausibility can be quantized using proprietary solutions or third party solutions such as, e.g., VPoser™, a variational autoencoder trained on large-scale pose data can evaluate the realism of a pose. For each frame t, the predicted SMPL body pose parameters

$${θ}_{t}^{pose}$$

are converted into compatible axis-angle representation φₜ∈ [symbol] ^{N}^{_{V}}^{×3}, then encoded to obtain a posterior q(zₜ|φₜ) over the latent pose space. The plausibility for each frame is quantified by the Kullback-Leibler (KL) divergence to a standard normal prior p(z). Other metrics are also contemplated.

Pose variation can be quantized using the temporal standard deviation of the pose vector φₜ (flattened dimension K=N_{V}×3) across frames. This quantifies diversity and motion magnitude. High variation reflects diverse and dynamic motions.

Trajectory Length can be quantized to assess the extent of global character movement within the 3D space. The trajectory length of the root joint can be calculated. For each frame t, the 3D key point coordinates can be provided. The total trajectory length is the sum of Euclidean distances between the root joint positions in consecutive frames. A longer trajectory length correlates to more substantial displacement of the character over time.

Optical flow score can be quantized to quantify the amount of motion and temporal dynamics. For each of the N_{cv}=4 views, dense optical flow between consecutive frames can be estimated. The score for each view is the average magnitude of these flow vectors across pixels and frames. The final optical flow score is the average of these per-view scores. A higher score signifies a more pronounced motion.

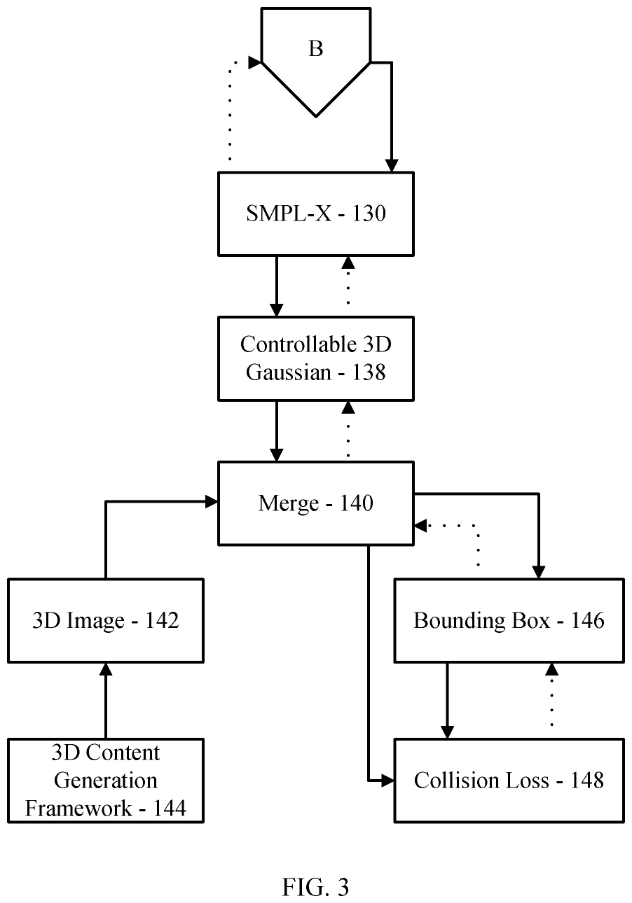

The workflow can include having the OAHM generate a human FIG. 3D image 132 (e.g. a person in yellow samurai dress) in a 3D Gaussian splat representation using 3D Human generation framework 136. The initial figure in 3D image 132 is in a rest position and each Gaussian point is then mapped to SMPL-X 130 mesh using controllable 3D Gaussian 138 to interact with 3D image 142. After this, the SMPL-X 130 motion can propagate to the Gaussian points to follow trajectory 118 according to motion sequence 126 using MDM 124. Motion sequence 126 is refined using trajectory loss and smoothing loss 128 and collision loss 148 (applying bounding boxes 146). The motions can be evaluated based on the metrics and refined until the metrics indicate appropriate motion is generated.

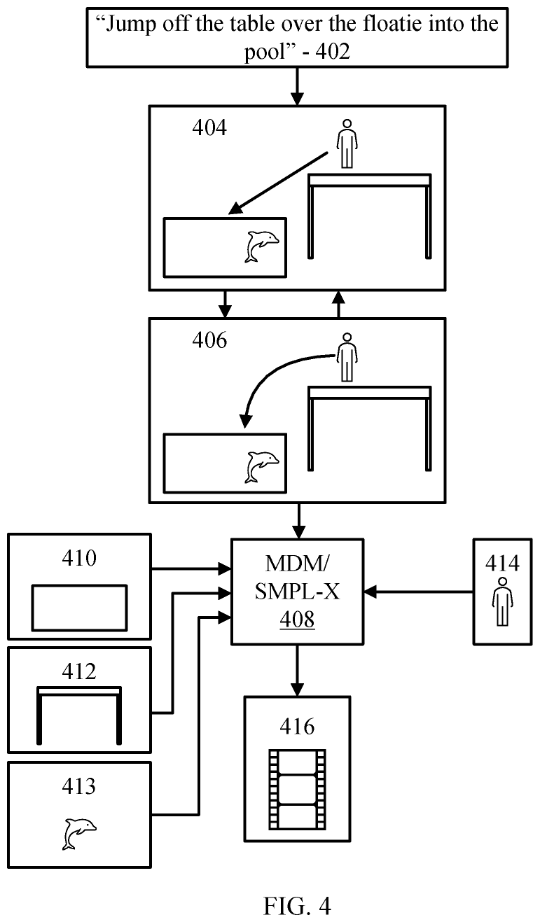

Referring to FIG. 4, a block diagram illustrating a diffusion model guided human-object interaction generation with 3D Gaussian is illustratively depicted, in accordance with an embodiment of the present invention. Prompt 402 can be natural language text, such as, e.g., “jump off the table over the floatie into the pool.” Prompt 402 can be more detailed or less detailed depending on the use/purpose and the sophistication of the user. Trajectory 404 can be formed from prompt 402. Trajectory 404 can have a path from point A to point B. The path can be a straight line for prompt 402, if the jump is considered diving. Context or other information (e.g., sentiment analysis of prompt 402, etc.) can also be included to iterate over trajectory 404 to change the path to form trajectory 406.

Instead of diving, which can cause a more linear path into the pool, trajectory 406 can follow an arc, which is likely to follow a kinematically accurate path, e.g., follows gravitational forces/physics. Further, trajectory 404 can initially land too closely, or on, the floatie, which is not realistic and does not abide by relevant/applicable priors. Trajectory 406 can land farther away from the floatie and generate a realistic motion. Trajectory 406 can be the final path. Any number of iterations can be used to generate a realistic motion path, or in some embodiments of the present invention, the number of iterations can be limited to limit computational resources used when generating the path.

Once trajectory 406 is set (e.g., immutable), the path can be sent to MDM/SMPL-X 408. The modules for MDM and SMPL-X can be separate or integrated, third-party or proprietary, or some combination thereof. In some embodiments of the present invention, the LLM receiving prompt 402, and other components of the present invention can also be separate or integrated, third-party or proprietary, or some combination thereof.

MDM/SMPL-X 408 can segregate each of the objects in trajectory 406. These objects can be pool 410, table 412, and floatie 413. Additionally, person 414 can be segregated. Each of pool 410, table 412, floatie 413, and person 414 can have a bounding box and have 3D Gaussian formed. The 3D Gaussians can be merged and the bounding boxes and ensure MDM/SMPL-X 408 avoid unrealistic collisions (e.g., collision detection and avoidance). Video 416 can then be formed from trajectory 406 with pool 410, table 412, floatie 413, and person 414. Video 416 can be realistic, abiding by physics according to priors in an LLM.

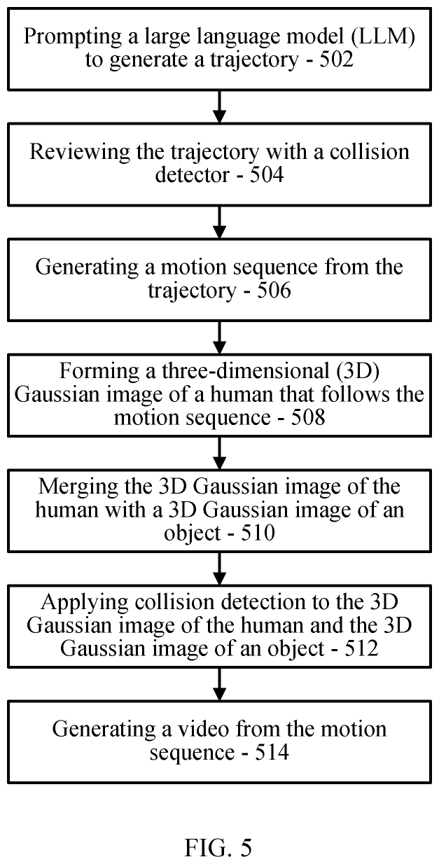

Referring to FIG. 5, a method of performing a diffusion model guided human-object interaction generation with 3D Gaussian is illustratively depicted, in accordance with an embodiment of the present invention.

In block 502, a large language model (LLM) is prompted to generate a trajectory. The prompt can be natural language, machine readable, visual, audio, or some combination thereof. The trajectory can consider physical priors, such as, e.g., motion priors. In block 504, the trajectory is reviewed with a collision detector. The collision detector can ensure the trajectory is realistic, accurate, plausible, etc. The trajectory can be iteratively optimized. In block 506, a motion sequence is generated from the trajectory. In block 508, a three-dimensional (3D) Gaussian image of a human that follows the motion sequence is formed. In block 510, the 3D Gaussian image of the human can be merged with a 3D Gaussian image of an object. In block 512, collision detection to the 3D Gaussian image of the human and the 3D Gaussian image of an object can be applied. In block 514, a video can be generated from the motion sequence.

In alternative embodiments of the present invention, optional features can also be included. Any number combination of optional features can be included. The optional embodiments of the present invention can include, generating bounding boxes of the 3D Gaussian image of the human and of the 3D Gaussian image of the object, and employing Gaussian splatting of the motion sequence to generate the video. Optional embodiments further include extracting actions from the trajectory and assigning a verb to describe the action, applying motion score distillation while forming the trajectory, having the motion sequence as a mesh and skinned multi-person linear model that transforms the mesh to a 3D Gaussian splatting mapping, and wherein prompting the LLM includes a zero-shot prompt.

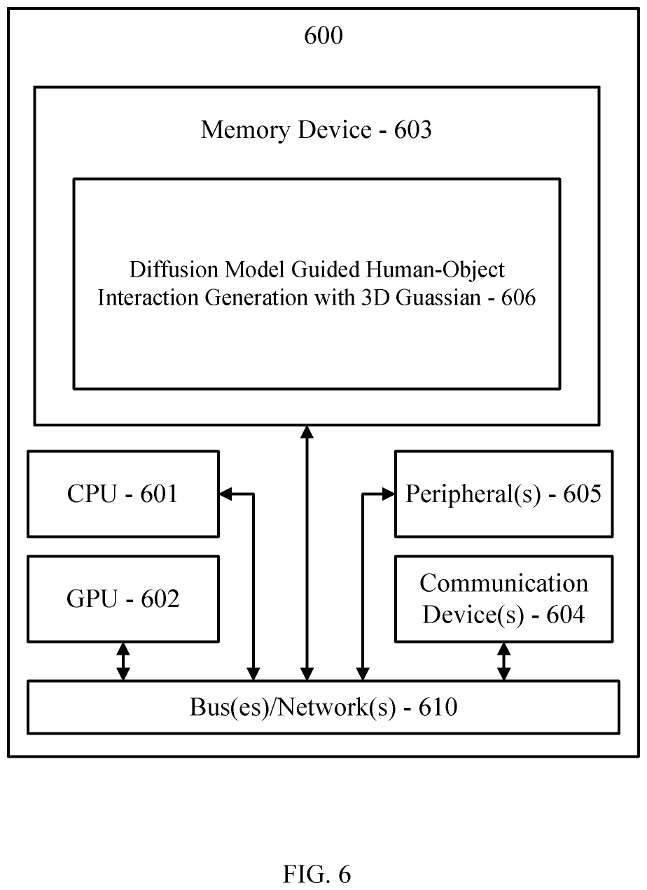

Referring to FIG. 6, a block diagram is shown for an exemplary processing system 600, in accordance with an embodiment of the present invention. The processing system 600 includes a set of processing units (e.g., CPUs) 601, a set of GPUs 602, a set of memory devices 603, a set of communication devices 604, and a set of peripherals 605. The CPUs 601 can be single or multi-core CPUs. The GPUs 602 can be single or multi-core GPUs. The one or more memory devices 603 can include caches, RAMs, ROMs, and other memories (flash, optical, magnetic, etc.). The communication devices 604 can include wireless and/or wired communication devices (e.g., network (e.g., Wi-Fi®, etc.) adapters, etc.). The peripherals 605 can include a display device, a user input device, a printer, an imaging device, and so forth. Elements of processing system 600 are connected by one or more buses or networks (collectively denoted by the figure reference numeral 610).

In an embodiment, memory devices 603 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 603 store program code or software 606 for diffusion model guided human-object interaction generation with 3D Gaussian. Software 606 includes a method for prompting a large language model (LLM) to generate a trajectory, the LLM applying motion priors, reviewing the trajectory with a collision detector, wherein the LLM and collision detector iteratively refine the trajectory to ensure the trajectory adheres to laws of physics, and generating a motion sequence from the trajectory. Software 606 can further include forming a three-dimensional (3D) Gaussian image of a human that follows the motion sequence, merging the 3D Gaussian image of the human with a 3D Gaussian image of an object, applying collision detection to the 3D Gaussian image of the human and the 3D Gaussian image of an object. and generating a video from the motion sequence. The memory devices 603 can store program code for implementing one or more functions of the systems and methods described herein.

Of course, the processing system 600 may also include other elements (not shown), as readily contemplated by one of skill in the art, as well as omitting certain elements. For example, various other input devices and/or output devices can be included in processing system 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 600.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method comprising:
prompting a large language model (LLM) to generate a trajectory, the LLM applying motion priors;
reviewing the trajectory with a collision detector, wherein the LLM and the collision detector iteratively refine the trajectory to ensure the trajectory adheres to laws of physics;
generating a motion sequence from the trajectory;
forming a three-dimensional (3D) Gaussian image of a human that follows the motion sequence;
merging the 3D Gaussian image of the human with a 3D Gaussian image of an object;
applying collision detection to the 3D Gaussian image of the human and the 3D Gaussian image of an object; and
generating a video from the motion sequence.

2. The method of claim 1, further comprising:
generating bounding boxes of the 3D Gaussian image of the human and of the 3D Gaussian image of the object.

3. The method of claim 1, further comprising:
employing Gaussian splatting of the motion sequence to generate the video.

4. The method of claim 1, further comprising:
extracting actions from the trajectory and assigning a verb to describe each action.

5. The method of claim 1, further comprising:
applying motion score distillation while forming the trajectory.

6. The method of claim 1, wherein the motion sequence is a mesh and skinned multi-person linear model transforms the mesh to a 3D Gaussian splatting mapping.

7. The method of claim 1, wherein prompting the LLM includes a zero-shot prompt.

8. A system comprising:
a processor; and
a memory storing computer-readable instructions that, when executed by the processor, cause the processor to:
prompt a large language model (LLM) to generate a trajectory, the LLM applying motion priors;
review the trajectory with a collision detector, wherein the LLM and the collision detector iteratively refine the trajectory to ensure the trajectory adheres to laws of physics;
generate a motion sequence from the trajectory;
form a three-dimensional (3D) Gaussian image of a human that follows the motion sequence;
merge the 3D Gaussian image of the human with a 3D Gaussian image of an object;
apply collision detection to the 3D Gaussian image of the human and the 3D Gaussian image of an object; and
generate a video from the motion sequence.

9. The system of claim 8, wherein the memory further causes the processor to:
generate bounding boxes of the 3D Gaussian image of the human and of the 3D Gaussian image of the object.

10. The system of claim 8, wherein the memory further causes the processor to:
employ Gaussian splatting of the motion sequence to generate the video.

11. The system of claim 8, wherein the memory further causes the processor to:
extract actions from the trajectory and assigning a verb to describe each action.

12. The system of claim 8, wherein the memory further causes the processor to:
apply motion score distillation while forming the trajectory.

13. The system of claim 8, wherein the motion sequence is a mesh and skinned multi-person linear model transforms the mesh to a 3D Gaussian splatting mapping.

14. The system of claim 8, wherein the prompt includes a zero-shot prompt.

15. A computer program product comprising a non-transitory computer-readable storage medium containing computer program code, the computer program code when executed by one or more processors causes the one or more processors to perform operations, the computer program code comprising instructions to:
prompt a large language model (LLM) to generate a trajectory, the LLM applying motion priors;
review the trajectory with a collision detector, wherein the LLM and the collision detector iteratively refine the trajectory to ensure the trajectory adheres to laws of physics;
generate a motion sequence from the trajectory;
form a three-dimensional (3D) Gaussian image of a human that follows the motion sequence;
merge the 3D Gaussian image of the human with a 3D Gaussian image of an object;
apply collision detection to the 3D Gaussian image of the human and the 3D Gaussian image of an object; and
generate a video from the motion sequence.

16. The computer program product of claim 15, wherein the one or more processors:
generate bounding boxes of the 3D Gaussian image of the human and of the 3D Gaussian image of the object.

17. The computer program product of claim 15, wherein the one or more processors:
employ Gaussian splatting of the motion sequence to generate the video.

18. The computer program product of claim 15, wherein the one or more processors:
extract actions from the trajectory and assigning a verb to describe each action.

19. The computer program product of claim 15, wherein the one or more processors:
apply motion score distillation while forming the trajectory.

20. The computer program product of claim 15, wherein the motion sequence is a mesh and skinned multi-person linear model transforms the mesh to a 3D Gaussian splatting mapping.
